(19) United States
(12) Patent Application Publication
(10) Pub. No.: US 2007/0132609 A1
(43) Pub. Date: Jun. 14, 2007

(54) Alarm/alert system for emergency vehicles

(75) Inventor: Scott D. Stackelhouse, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/302,297

(22) Filed: Dec. 13, 2005

(51) Int. Cl. G08G 1/00

(52) U.S. Cl. 340/904

(57) ABSTRACT

A system for alerting motorists about an approaching emergency vehicle is disclosed, which broadcasts an emergency warning message that motorists can readily hear and use to determine the approach direction of the emergency vehicle. For example, a system for alerting motorists about an approaching emergency vehicle is disclosed, which includes a transmitter unit for the emergency vehicle that broadcasts an emergency warning message over a short range radio frequency, a GPS receiver unit for the emergency vehicle that provides the emergency vehicle's position, and a processor unit that regularly retrieves the emergency vehicle's position data, determines the emergency vehicle's heading, and generates the emergency warning message including pertinent position and heading information. Thus, a motorist within broadcast range can receive and hear the emergency warning message on the radio of the motorist's vehicle, and ascertain from the message the nearness and approach direction of the emergency vehicle.

### FIELD OF THE INVENTION

The present invention relates generally to the field of emergency warning systems, and more specifically, but not exclusively, to an alarm system for emergency vehicles that alerts motorists in other vehicles about an emergency vehicle's approach.

### BACKGROUND OF THE INVENTION

Emergency vehicles often cause significant traffic safety problems. For example, when responding to emergencies, emergency vehicles often have to exceed posted speed limits, pass other vehicles where it may be hazardous to pass, and cross intersections against the lights. These actions may be necessary to minimize the emergency vehicles' response times, but they create hazardous conditions for the other vehicles and the emergency vehicles involved.

In order to warn motorists in other vehicles, emergency vehicles typically activate their sirens and honk their horns. However, sirens and horns are inadequate, because they are often not heard by motorists until the emergency vehicles are very near. For example, an emergency vehicle's siren and horn may not be heard by a motorist, because the motorist may be listening to a radio playing loudly or talking to someone else on a cellular phone. Also, many modern vehicles are designed to be more soundproof, which makes the emergency vehicles' sirens and horns more difficult for motorists to hear. Furthermore, although a motorist may eventually hear an emergency vehicle's siren or horn, the motorist may not be able to determine the direction of the sound. Therefore, a need exists for a system that warns motorists about an approaching emergency vehicle, which also enhances the ability of the motorists to hear and respond to the warning. Also, a need exists for an emergency vehicle warning system, which indicates to motorists the travel direction of the emergency vehicle involved. As described in detail below, the present invention provides such a system, which resolves the existing emergency vehicle warning problems and other similar problems.

### SUMMARY OF THE INVENTION

The present invention provides a system for alerting motorists about an approaching emergency vehicle, by broadcasting an emergency warning message that motorists can readily hear and use to determine the approach direction of the emergency vehicle. In accordance with a preferred embodiment of the present invention, a system for alerting motorists about an approaching emergency vehicle is provided, which includes a transmitter unit for the emergency vehicle that broadcasts an emergency warning message over a short range radio frequency, a GPS receiver unit for the emergency vehicle that provides the emergency vehicle's position, and a processor unit that regularly retrieves the emergency vehicle's position data, determines the emergency vehicle's heading, and generates the emergency warning message including pertinent position and heading information. Thus, a motorist within broadcast range can receive and hear the emergency warning message on the radio of the motorist's vehicle, and ascertain from the message the nearness and approach direction of the emergency vehicle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a top-down view of a roadway intersection and an emergency vehicle alarm/alert system, which illustrates a preferred embodiment of the present invention; and

FIG. 2 depicts a block diagram of an example emergency vehicle alarm/alert system, which can be used to implement the emergency vehicle alarm/alert system shown in FIG. 1.

### DETAILED DESCRIPTION OF PREFERRED EMBODIMENT

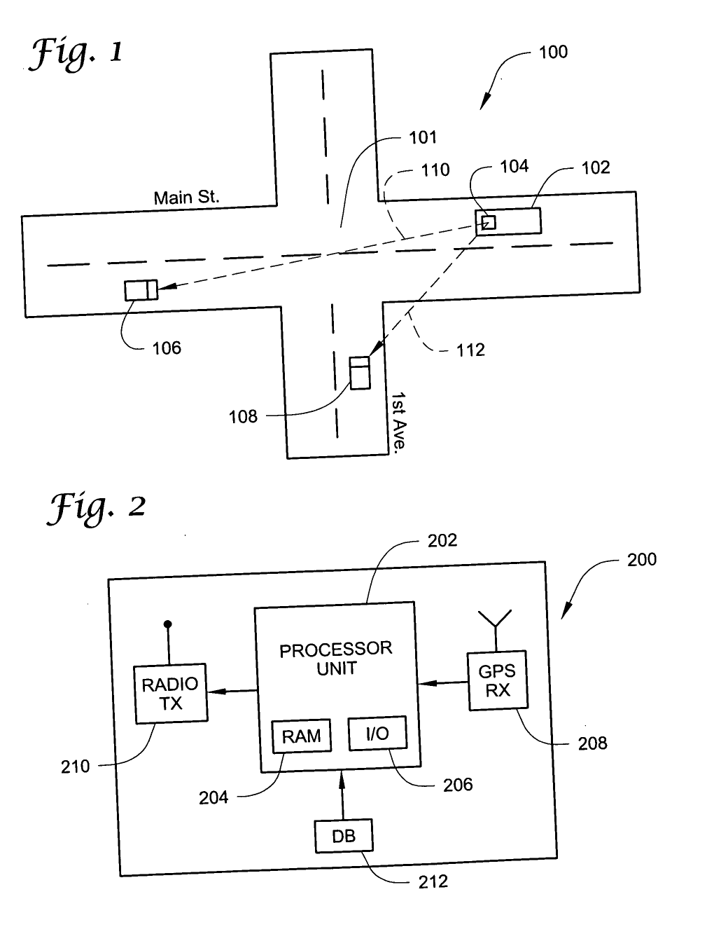

With reference now to the figures, FIG. 1 depicts a top-down view of a roadway intersection and an emergency vehicle alarm/alert system 100, which illustrates a preferred embodiment of the present invention. For this example embodiment, system 100 includes an emergency vehicle 102 and a plurality of vehicles 106, 108 approaching a roadway intersection 101 (e.g., identified as the intersection of Main Street and 1^{st} Avenue). The emergency vehicle 102 is conveying an emergency vehicle alarm/alert system 104, which broadcasts or transmits an emergency message to be received by each vehicle of the plurality of vehicles 106, 108. For this example, such an emergency message broadcast or transmission is indicated by the dashed lines 110, 112. The transmitted emergency message (e.g., 110, 112) is preferably a synthesized audio message that states, for example, “Alert. Emergency vehicle traveling West on Main Street. Approaching intersection of Main Street and 1^{st} Avenue.” At this point, it should be understood that although only two vehicles 106, 108 and respective emergency messages 110, 112 are shown, the present invention is not intended to be so limited and can include any suitable number of vehicles that can, for example, avoid a collision with emergency vehicle 102 and/or avoid impeding the movement and response time of emergency vehicle 102. The emergency message (e.g., 110, 112) is regularly updated with the most current heading of the emergency vehicle 102 as it traverses the route to its intended destination. Also, the emergency message is regularly updated with suitable information describing the next roadway intersection being approached, as the emergency vehicle 102 continues to traverse its route.

FIG. 2 depicts a block diagram of an example emergency vehicle alarm/alert system 200, which can be used to implement emergency vehicle alarm/alert system 104 shown in FIG. 1. For this example embodiment, system 200 includes a processor unit 202, a GPS receiver unit 208, a radio transmitter unit 210, and a map database unit 212. For example, processor unit 202 can be a digital processor, which functions primarily to execute suitable software instructions in order to receive latitudinal and longitudinal coordinate data from GPS receiver unit 208, compare the received latitudinal and longitudinal coordinate data with mapped latitudinal and longitudinal coordinate data retrieved from map database unit 212, determine the heading and position of an associated emergency vehicle (e.g., 102 in FIG. 1) with respect to the mapped data retrieved, create an emergency message (e.g., 110, 112) including the direction of the emergency vehicle involved, the name of the road upon which the emergency vehicle is currently traveling, and the name of the nearest intersection being approached by the emergency vehicle involved, and forward the emergency message (e.g., updated on a regular basis) to the radio transmitter unit 210 to be transmitted and/or broadcast.

For this example embodiment, processor unit 202 can be a microprocessor, digital signal processor, microcontroller, embedded processor, or a processor based on a PowerPC® processing architecture. For example, processor unit 202 can be arranged as a single processor or plurality of processors connected to a data communications bus or system bus. A memory controller/cache can also be connected to the data communications bus or system bus, which can provide an interface between processor unit 202 and a local memory (e.g., RAM 204, ROM, etc.). A plurality of machine instructions can be stored in the local memory and retrieved and operated on by processor unit 202 to, for example, retrieve or receive GPS coordinate data associated with the instant position of the emergency vehicle involved, and interpret, process, and compare the GPS coordinate data with the coordinate data retrieved from map database unit 212. An Input/Output (I/O) bus bridge can also be connected to the data communications bus or system bus, which can provide an interface between processor unit 202 and an I/O bus 206. Thus, processor unit 202 can receive, retrieve and/or send coordinate data and emergency message data via such an I/O bus 206. In any event, those of ordinary skill in the art will appreciate that the hardware described herein for processor unit 202 in FIG. 2 may vary. As such, the depicted example is provided for illustrative purposes and not meant to imply any architectural limitations with respect to the present invention.

Notably, for this example embodiment, processor unit 202 can determine the position of the associated emergency vehicle at any point in time, by receiving the coordinate information (e.g., current latitude and longitude coordinate data) from the GPS receiver unit 208. Processor unit 202 can then retrieve from map database unit 212 a predetermined amount of mapped highway, roadway or freeway network data associated with the GPS coordinate data received. For example, processor unit 202 can retrieve (from map database unit 212) four city blocks (or a suitable amount of similar data) of roadway data directly in front, and to the right and left, of the emergency vehicle involved. In this way, processor unit 202 can compare this data with the GPS coordinate data and determine the identity of the road being traveled by the emergency vehicle, and also the identity of the next intersection being approached by the emergency vehicle. Also, processor unit 202 can determine the heading of the emergency vehicle by comparing a sequence of received GPS coordinates and thus determining the direction of the emergency vehicle. Alternatively, the GPS receiver unit 208 can provide heading information to processor 202 in addition to the latitudinal and longitudinal coordinate data. Processor unit 202 then creates an emergency message (e.g., using a digital voice synthesizer) including, for example, such information as the emergency vehicle's heading, the name of the road on which the emergency vehicle is traveling, and the name of the intersection that the emergency vehicle is approaching. The emergency message is then forwarded to radio transmitter unit 210 for broadcast or transmission. For example, processor unit 202 might send a control signal to transmitter unit 210 that causes the transmitter unit to broadcast or transmit the emergency message continuously while the emergency vehicle's siren is activated.

For this example embodiment, radio transmitter unit 210 can be a suitable transmitter including an omni-directional antenna capable of transmitting emergency vehicle alarm/alert messages (e.g., 110, 112 in FIG. 1) at commercial FM radio frequencies, commercial AM radio frequencies, and/or commercial satellite radio frequencies. In a different arrangement, radio transmitter unit 210 can be composed of two or three of such transmitter units (e.g., in order to broadcast an emergency message simultaneously over the AM and FM frequencies, the AM, FM and satellite frequencies, etc.). In any event, radio transmitter unit 210 can be implemented with a suitable transmitter capable of transmitting emergency vehicle alarm/alert messages over the entire FM broadcast radio frequency band (e.g., 88 MHz-108 MHz). Thus, radio transmitter 210 can be a broad spectrum transmitter that is broadly tuned so as to broadcast an emergency message over the entire FM frequency band, or a scanning transmitter that scans the FM frequency band and broadcasts an emergency message at each FM frequency actually used by the FM radio stations in the local radio market involved. For example, the range of the transmitted FM radio signal can be about 500-1,000 feet.

Similarly, in accordance with another embodiment of the present invention, radio transmitter unit 210 can be implemented with a suitable transmitter capable of transmitting emergency vehicle alarm/alert messages over the entire AM broadcast radio frequency band (e.g., 530 kHz-1700 kHz). As such, radio transmitter 210 can be a broad spectrum transmitter that is broadly tuned so as to broadcast an emergency message over the entire AM frequency band, or a scanning transmitter that scans the AM frequency band and broadcasts an emergency message at each AM frequency actually used by the AM radio stations in the local radio market involved. Again, the range of the transmitted AM radio signal can be about 500-1,000 feet.

Additionally, in accordance with still another embodiment of the present invention, radio transmitter unit 210 can be implemented with a suitable transmitter capable of transmitting emergency vehicle alarm/alert messages over the commercial satellite radio frequency band (e.g., 2.3 GHz S band). As such, radio transmitter 210 can be a broad spectrum transmitter, or a scanning transmitter that scans the satellite radio frequency band and broadcasts an emergency message at each frequency actually used by the satellite radio stations in the local radio market involved (e.g., 2,320.00 MHz and 2,345.00 MHz). Again, the range of the transmitted satellite radio signal can be about 500-1,000 feet.

Thus, in accordance with teachings of the present invention, an operating radio receiver in a motorist's vehicle (e.g., 106, 108 in FIG. 1) can receive the broadcast emergency message from radio transmitter 210 on the motorist's FM, AM and/or satellite radio receiver. The motorist can hear the emergency message (e.g., 110, 112) including the heading and intersection approach information, and take appropriate action to avoid a collision with the emergency vehicle (e.g., 102) and not impede its movement. In this way, the present invention enhances highway safety and the emergency vehicle's response time.

It is important to note that while the present invention has been described in the context of a fully functioning emergency vehicle alarm/alert system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular emergency vehicle alarm/alert system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. An emergency vehicle alarm system, comprising:
a navigation receiver unit, said navigation receiver unit operable to determine at least one position of said navigation receiver unit in latitudinal and longitudinal coordinate form;
a database unit, said database unit operable to store a map database including an identity for each road of a plurality of roads, and a plurality of road positions associated with said each road in latitudinal and longitudinal coordinate form;
a transmitter unit; and
a processor unit coupled to said navigation receiver unit, said database unit and said transmitter unit, said processor unit operable to:
receive said at least one position of said navigation receiver unit;
compare said at least one position of said navigation receiver unit with said plurality of road positions in latitudinal and longitudinal form;
determine a heading and an identity of a road associated with a movement of said navigation receiver unit;
determine an identity of an intersection of said road and a second road associated with said heading of said navigation receiver unit;
create an alert message including information describing said heading, said identity of said road, and said identity of said intersection; and
send said alert message to said transmitter unit for transmission.

2. The system of claim 1, wherein said navigation receiver unit comprises a GPS receiver.

3. The system of claim 1, wherein said transmitter unit comprises a radio broadcast transmitter.

4. The system of claim 1, wherein said transmitter unit comprises an FM radio transmitter.

5. The system of claim 1, wherein said transmitter unit comprises an AM radio transmitter.

6. The system of claim 1, wherein said transmitter unit comprises a satellite radio transmitter.

7. The system of claim 1, wherein said transmitter unit comprises at least two of an FM radio transmitter, an AM radio transmitter, and a satellite radio transmitter.

8. The system of claim 1, wherein said system is conveyed on an emergency vehicle.

9. The system of claim 1, wherein said system is conveyed on an emergency vehicle, and said transmitter unit is operable to transmit said alert message responsive to an operation of a siren of said emergency vehicle.

10. The system of claim 1, wherein said alert message comprises an audio message.

11. An emergency vehicle alarm system, comprising:
means for determining at least one position of an emergency vehicle in latitudinal and longitudinal coordinate form;
means for storing a map database including an identity for each road of a plurality of roads, and a plurality of road positions associated with said each road in latitudinal and longitudinal coordinate form;
means for transmitting an alert message; and
processing means, coupled to said means for determining, said means for storing and said means for transmitting, for receiving said at least one position of said emergency vehicle, comparing said at least one position with said plurality of road positions in latitudinal and longitudinal form, determining a heading and an identity of a road associated with a movement of said emergency vehicle, determining an identity of an intersection of said road and a second road associated with said heading of said emergency vehicle, creating an alert message including information describing said heading, said identity of said road, and said identity of said intersection, and sending said alert message to said means for transmitting.

12. The system of claim 11, wherein said means for determining comprises a GPS receiver.

13. The system of claim 11, wherein said means for transmitting comprises a radio broadcast transmitter.

14. The system of claim 11, wherein said means for transmitting comprises an FM radio transmitter.

15. The system of claim 11, wherein said means for transmitting comprises an AM radio transmitter.

16. The system of claim 11, wherein said means for transmitting comprises a satellite radio transmitter.

17. A method for alerting a motorist to an approaching emergency vehicle, comprising:
determining at least one position of an emergency vehicle in latitudinal and longitudinal coordinate form;
storing a map database including an identity for each road of a plurality of roads, and a plurality of road positions associated with said each road in latitudinal and longitudinal coordinate form;
receiving said at least one position of said emergency vehicle;
comparing said at least one position with said plurality of road positions in latitudinal and longitudinal form;
determining a heading and an identity of a road associated with a movement of said emergency vehicle;
determining an identity of an intersection of said road and a second road associated with said heading of said emergency vehicle;
creating an alert message including information describing said heading, said identity of said road, and said identity of said intersection; and
transmitting said alert message over at least one of an FM broadcast band, an AM broadcast band, and a satellite radio broadcast band.

18. A computer program product, comprising:
a computer-usable medium having computer-readable code embodied therein for configuring a computer processor, the computer program product comprising:
a first executable computer-readable code configured to cause a computer processor to determine at least one position of an emergency vehicle in latitudinal and longitudinal coordinate form;
a second executable computer-readable code configured to cause a computer processor to store a map database including an identity for each road of a plurality of roads, and a plurality of road positions associated with said each road in latitudinal and longitudinal coordinate form;
a third executable computer-readable code configured to cause a computer processor to receive said at least one position of said emergency vehicle;
a fourth executable computer-readable code configured to cause a computer processor to compare said at least one position with said plurality of road positions in latitudinal and longitudinal form;
a fifth executable computer-readable code configured to cause a computer processor to determine a heading and an identity of a road associated with a movement of said emergency vehicle;
a sixth executable computer-readable code configured to cause a computer processor to determine an identity of an intersection of said road and a second road associated with said heading of said emergency vehicle;
a seventh executable computer-readable code configured to cause a computer processor to create an alert message including information describing said heading, said identity of said road, and said identity of said intersection; and
an eighth executable computer-readable code configured to cause a computer processor to transmit said alert message over at least one of an FM broadcast band, an AM broadcast band, and a satellite radio broadcast band.

19. The computer program product of claim 18, further comprising:
a ninth executable computer-readable code configured to cause a computer processor to transmit said alert message responsive to an operation of a siren of said emergency vehicle.

20. The computer program product of claim 18, further comprising:
a tenth executable computer-readable code configured to cause a computer processor to synthesize said emergency message in audible form.
